(19) United States
(12) Patent Application Publication
(10) Pub. No.: US 2023/0266710 A1
(43) Pub. Date: Aug. 24, 2023

(54) METHOD AND DEVICE FOR RECONSTRUCTING A DIGITAL HOLOGRAM, METHOD FOR DISPLAYING A DIGITAL HOLOGRAM AND ASSOCIATED SYSTEM

(71) Applicant: FONDATION B-COM, Cesson-Sévigné (FR)

(72) Inventors: Antonin GILLES, Rennes (FR); Patrick GIOIA, SERVON-SUR-VILAINE (FR)

(21) Appl. No.: 18/012,864

(22) PCT Filed: Jun. 21, 2021
(86) PCT No.: PCT/EP2021/066876

§ 371 Date: Dec. 23, 2022

(30) Foreign Application Priority Data
Jun. 26, 2020 (FR) FR2006710

(51) Int. Cl. G03H 1/08

(52) U.S. Cl. CPC G03H 1/0808; G03H 1/0866; G03H 1/0891

(57) ABSTRACT

A digital hologram is represented by a set of coefficients respectively associated with a plurality of definition wavelets each defined by a tuple of coordinates in a multidimensional space. A method for reconstructing the digital hologram in order to display it by a display, includes the following steps: depending on at least one data item representative of a characteristic of the display, determining a transformation of the multidimensional space; and generating a reconstructed hologram by assigning each coefficient of at least some of the coefficients to a reconstruction wavelet defined by an image reconstruction tuple by the predetermined transformation of the tuple of coordinates defining the definition wavelet associate with the coefficient in question. An associated display method, reconstruction device and system are also described.

### CROSS-REFERENCE TO RELATED APPLICATIONS

This application is the U.S. national phase of International Application No. PCT/EP2021/066876 filed Jun. 21, 2021 which designated the U.S. and claims priority to FR Patent Application No. 2006710 filed Jun. 26, 2020, the entire contents of each of which are hereby incorporated by reference.

### BACKGROUND OF THE INVENTION

### Field of the Invention

The present invention relates to the technical field of digital holography.

It more particularly relates to a method and a device for reconstructing a digital hologram, a method for displaying a digital hologram and an associated system.

### Description of the Related Art

It has already been proposed, for example in the article “View-dependent compression of digital hologram based on matching pursuit”, by Anas El Rhammad, Patrick Gioia, Antonin Gilles, Marco Cagnazzo and Beatrice Pesquet-Popescu in Optics, Photonics, and Digital Technologies for Imaging Applications V. International Society for Optics and Photonics, 2018, vol. 10679, p.106790L, to represent a digital hologram by means of a set of coefficients respectively associated with a plurality of definition wavelets each defined by a tuple of coordinates in a multidimensional space.

These definition wavelets are for example Gabor wavelets ϕ_{θ,ξ,x,y} defined by a tuple of 4 coordinates comprising two angular coordinates θ,ξ and two spatial coordinates x,y in the plane of the digital hologram (these 4 coordinates defining physical characteristics of the wavelet in question, i.e. in the case of the Gabor wavelet: the position and direction of a diffracted ray corresponding to the Gabor wavelet in question).

The digital hologram to be displayed is obtained by summing all the definition wavelets with weighting of each definition wavelet by the coefficient associated with this definition wavelet.

### SUMMARY OF THE INVENTION

In this context, the present invention proposes a method for reconstructing a digital hologram for it to be displayed by means of a display device, the digital hologram being represented by a set of coefficients respectively associated with a plurality of definition wavelets each defined by a tuple of coordinates in a multidimensional space, comprising the following steps:

based on at least one data item representative of a characteristic of the display device, determining a transformation of said multidimensional space;

generating a reconstructed hologram by assigning each coefficient of at least some of said coefficients to a reconstruction wavelet defined by a reconstruction tuple image by the determined transformation of the tuple of coordinates defining the definition wavelet associated with the coefficient in question.

The reconstructed hologram is thus adapted to the display device by means of which it is provided to display the digital hologram. As explained hereinafter, this adaptation may be for example an adaptation to a construction characteristic of the display device, or to an adaptation to the position and/or direction of the display device.

For example, in practice, only the coefficients whose associated definition wavelet is defined by a tuple of coordinates whose image by the determined transformation verifies a predefined criterion are assigned. This makes it possible to use (and in certain cases to transmit) only the coefficients actually relevant for the display on the envisaged display device.

The above-mentioned characteristic of the display device may be for example a construction characteristic of the display device.

The above-mentioned characteristic of the display device may also be a position or direction characteristic of the display device.

Moreover, the above-mentioned transformation may be determined based on a first data item representative of a construction characteristic of the display device and a second data item representative of a position or direction characteristic of the display device.

In embodiments, the step of generating a reconstructed hologram may comprise the following sub-steps:

assigning each coefficient associated with a definition wavelet, defined by a given tuple, to a reconstruction wavelet defined by the image of the given tuple by the determined transformation;

selecting the coefficients assigned to reconstruction wavelets defined by tuples verifying a predetermined criterion (for example, the already mentioned predefined criterion).

In other embodiments, the step of generating a reconstructed hologram may comprise the following sub-steps:

determining a criterion modified based on the determined transformation and a determined criterion (for example the above-mentioned predefined criterion);

selecting the coefficients whose associated definition wavelet is defined by a tuple of coordinates verifying the modified criterion.

In practice, the step of generating a reconstructed hologram can moreover comprise at least one sub-step of scanning a binary tree whose leaves correspond to the coefficients of said set.

The invention also proposes a method for displaying a digital hologram comprising the following steps:

reconstructing the digital hologram by a method such as that proposed hereinabove;

displaying the reconstructed hologram by means of said display device.

For displaying the reconstructed hologram, such a display method may comprise a step of calculating the reconstructed hologram by summing the reconstruction wavelets with weighting of each reconstruction wavelet by the coefficient assigned to this reconstruction wavelet.

The invention moreover proposes a device for reconstructing a digital hologram for it to be displayed by a display device, comprising:

a module for storing a representation of the digital hologram comprising a set of coefficients respectively associated with a plurality of definition wavelets each defined by a tuple of coordinates in a multidimensional space;

a module for determining a transformation of said multidimensional space based on at least one data representative of a characteristic of the display device;

a reassignment module designed to generate a reconstructed hologram by assigning each coefficient of at least some of said coefficients to a reconstruction wavelet defined by a reconstruction tuple image by the determined transformation of the tuple of coordinates defining the definition wavelet associated with the coefficient in question.

Such a reconstruction device may further comprise:

a module for receiving said representative data item; and/or

a module for transmitting the assigned coefficients and, possibly, for each assigned coefficient, information indicative of the reconstruction wavelet to which this selected coefficient is assigned in the reconstructed hologram.

The invention finally proposes a system comprising a device for reconstructing a digital hologram as defined hereinabove, and said display device.

Such a system may further comprise a module capable of calculating the reconstructed hologram by summing the reconstruction wavelets with weighting of each reconstruction wavelet by the coefficient assigned to this reconstruction wavelet.

Of course, the different features, alternatives and embodiments of the invention can be associated with each other according to various combinations, insofar as they are not mutually incompatible or exclusive.

### BRIEF DESCRIPTION OF THE DRAWINGS

Moreover, various other features of the invention will be apparent from the appended description made with reference to the drawings that illustrate non-limiting embodiments of the invention, and wherein:

FIG. 1 schematically shows a system for displaying a digital hologram;

FIG. 2 schematically shows an example of display device usable in the system of FIG. 1;

FIG. 3 is a flowchart showing an example of a method for reconstructing a digital hologram according to the invention;

FIG. 4 shows an alternative embodiment for certain steps of the method of FIG. 3;

FIG. 5 schematically shows a plane mirror and a converging lens used to model a parabolic mirror; and

FIG. 6 shows angles used in the following description.

### DESCRIPTION OF THE PREFERRED EMBODIMENTS

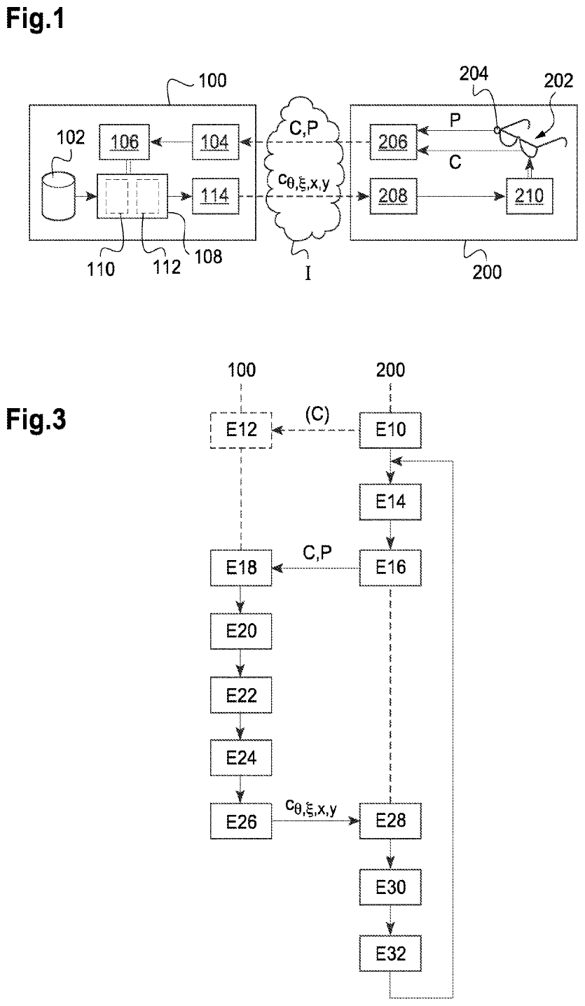

FIG. 1 shows a system according to a possible embodiment of the invention.

The system of FIG. 1 comprises an electronic device 100 and a display unit 200.

As will be understood from the following description, the electronic device 100 forms a device for reconstructing a digital hologram as proposed by the invention.

In the example described here, the electronic device 100 and the display unit 200 are distant from each other and exchange data between each other via a communication network I (or, as an alternative, several interconnected communication networks), as will be described in more detail hereinafter. The electronic device 100 can then form a server capable of providing data to the display unit 200 (that then forms a client) for displaying a digital hologram, as described hereinafter.

The electronic device 100 comprises a storage module 102, a reception module 104, a transformation determination module 106, a processing unit 108 and a transmission module 114.

In practice, the above-mentioned modules and unit 102, 104, 106, 108, 114 can be implemented by the cooperation of at least one hardware element (such as a processor of the electronic device 100 and/or, in particular for the reception module 104 and/or the transmission module 114, a communication circuit) and software elements (such as computer-program instructions executable by the above-mentioned processor).

These computer-program instructions can in particular be such that the electronic device 100 implements a part at least of the steps described hereinafter with reference to FIGS. 3 and 4 when these instructions are executed by the processor of the electronic device 100.

The storage module 102 (made in practice by means of a memory or a drive disk) stores a representation of a digital hologram H comprising a set of coefficients c_{θ,ξ,x,y} associated with a plurality of definition wavelets ϕ_{θ,ξ,x,y} respectively, each defined by a tuple of coordinates (θ, ξ, x, y) in a multidimensional space E (here a 4-dimensional space).

The definition wavelets ϕ_{θ,ξ,x,y} are here Gabor-Morlet wavelets, which are each defined by a quadruplet (θ, ξ, x, y) comprising:

a first coordinate 6 that defines the direction of a diffracted ray associated with the wavelet ϕ_{θ,ξ,x,y} in question;

a second coordinate that defines the spatial frequency of this diffracted ray;

a third coordinate x and a fourth coordinate y that define the position of this diffracted ray in the plane of the digital hologram H.

Such a representation of the digital hologram H comprises in practice a predetermined number of coefficients c_{θ,ξ,x,y} in relation with a discretization of the multidimensional space E of the definition parameters (θ, ξ, x, y) of the wavelets ϕ_{θ,ξ,x,y}.

For example, the representation of the digital hologram H comprises coefficients θ_{θ,ξ,x,y} associated with the definition wavelets ϕ_{θ,ξ,x,y} respectively, defined by tuples of the form (θₖ, ξ_{I}, xₘ, yₙ) with:
θₖ=2πk/N_{θ} for k an integer between 0 and N_{θ}−1,
ξ_{I}=I.Δ_{ξ} for I an integer between −N_{ξ} and N_{ξ},
xₘ=m.Δₓ for m an integer between −Nₓ and Nₓ,
yₙ=n.Δ_{y} for n an integer between −N_{y} and N_{y},

where N_{θ}, N_{ξ}, Nₓ, N_{y} are predefined integer numbers (that affect the number of coefficients c_{θ,ξ,x,y} used in the representation) and where Δ_{ξ}, Δₓ, Δ_{y} are predefined discretization pitches.

The so-represented digital hologram H can be written:

H=Y_{k,l,m,n}ϕ_{θk,ξl,xm,yn}.c_{θk,ξl,xm,yn}.

The reception module 104 is adapted to receive data via the above-mentioned communication network I, in particular data C, P representative of characteristics of a display device 202 of the display unit 200.

As explained more precisely hereinafter, these data representative of characteristics of the display device 202 may be data C representative of a construction characteristic of the display device 202 and/or data P representative of a position or direction characteristic of the display device 202.

The transformation determination module 106 is designed to determine a transformation σ of the above-mentioned multidimensional space E as a function of the data C, P representative of the characteristics of the display device 202 received by the reception module 104.

Different examples of determination of such a transformation a are given hereinafter in the present disclosure. Moreover, as explained hereinafter, this transformation a is used to generate a reconstructed (digital) hologram H′ based on the digital hologram H by taking into account the characteristics of the display device 202.

The processing unit 108 comprises a selection module 110 and a reassignment module 112.

The selection module 110 is designed to select the coefficients c_{θ,ξ,x,y} whose associated definition wavelet ϕ_{θ,ξ,x,y} is defined by a tuple of coordinates (θ, ξ, x, y) whose image (θ′, ξ′, x′, y′) by the transformation σ (determined by the transformation determination module 106) verifies a predetermined criterion. (With the above notation, we hence have: (θ′, ξ′, x′, y′)=σ[(θ, ξ, x, y)].

The predetermined criterion is for example the fact that the image (θ′, ξ′, x′, y′) belongs to a predefined sub-set of the multidimensional space E, as explained hereinafter.

The selection module 110 thus makes it possible to select only the coefficients c_{θ,ξ,x,y} that are relevant for a display on the display device 202 (by taking into account the characteristics of the display device 202 via the transformation σ).

The reassignment module 112 is designed to assign a given coefficient c_{θ,ξ,x,y} to a wavelet ϕ_{θ,ξ,x,y} called hereinafter “reconstruction wavelet”, different from the definition wavelet ϕ_{θ,ξ,x,y} associated with this coefficient c_{θ,ξ,x,y} and defined by a reconstruction tuple (θ′, ξ′, x′, y′) image by the transformation a of the tuple coordinates (θ, ξ, x, y) defining this definition wavelet ϕ_{θ,ξ,x,y} (i.e. we have: (θ′, ξ′, x′, y′)=σ[(θ, ξ, x, y)]).

As explained hereinafter, by taking into account the characteristics of the display device 202 thanks to the transformation a, this new assignment of the coefficients makes it possible to generate a reconstructed hologram H′ whose display by the display device 202 will best recreate the digital hologram H for the user.

The transmission module 114 is capable of transmitting data on the communication network I (in particular to the display unit 200). The transmission module 114 can transmit in particular the coefficients c_{θ,ξ,x,y} selected by the selection module 110, as well as possibly, for each selected coefficient c_{θ,ξ,x,y} information indicative of the reconstruction wavelet ϕ_{θ′,ξ′,x′,y′} to which the selected coefficient c_{θ,ξ,x,y} is assigned by the reassignment module 112 (and hence in the reconstructed hologram H′). As an alternative, the reconstruction wavelet ϕ_{θ,ξ,x,y} to which a transmitted coefficient c_{θ,ξ,x,y} is assigned could be derived from the position of this coefficient c_{θ,ξ,x,y} in the flow of data. In other words, the flow of data comprises in this case the coefficients ordered in an order determined by the reconstruction wavelets to which the coefficients are assigned (the reconstruction wavelets being themselves ordered in a predefined order).

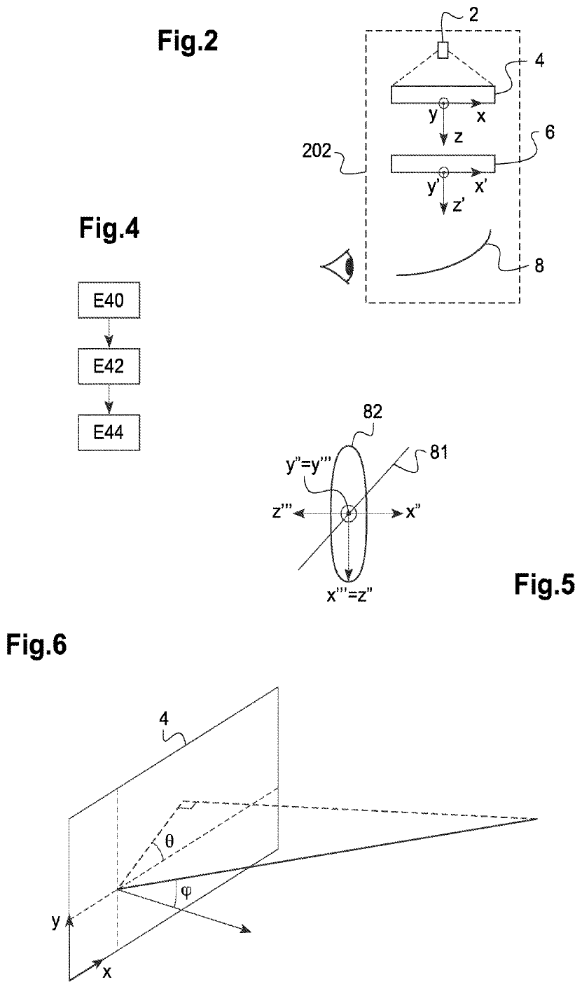

The display unit 200 comprises the already-mentioned display device 202, a position and/or direction sensor 204, a transmission module 206, a reception module 208 and a control module 210. An example of display device 202 is described hereinafter with reference to FIG. 2.

In practice, the above-mentioned modules 206, 208, 210 can be implemented by the cooperation of at least one hardware element (such as a processor of the display unit 200 and/or, in particular for the reception module 208 and/or the transmission module 206, a communication circuit) and software elements (such as computer-program instructions executable by the above-mentioned processor).

These computer-program instructions can in particular be such that the display unit 200 implements a part at least of the steps described hereinafter with reference to FIG. 3 when these instructions are executed by the processor of the display unit 200.

The position and/or direction sensor 204 is linked to the display device 202 and provides data P representative of the position and/or direction of the display device 202.

Precisely, the position of the display device 202 is for example defined by a translation T and the direction of the display device 202 by a rotation R. The position and/or direction sensor 204 comprises for example an Inertial Measurement Unit, or IMU.

The use of such a position and/or direction sensor 204 is interesting in particular when the display device 202 is of the portable type (as this is the case in the example described herein, as explained hereinafter). Such a position and/or direction sensor could however be omitted in embodiments of the invention in which it is not searched to know the position or direction of the display device (the invention making it possible, in this case, to take into account other characteristics of the display device, such as for example construction characteristics).

The transmission module 206 is capable of transmitting data on the communication network I, in particular to the electronic device 100 (via the reception module 104 of the electronic device 100).

The transmission module 206 can hence transmit (to the electronic device 100) data C representative of a construction characteristic of the display device 202 (these data C being for example provided directly by the display device 202) and/or data P representative of a position or direction characteristic of the display device 202 (here the data P produced by the position and/or direction sensor 204).

On its side, the reception module 208 is capable of receiving data on the communication network I, in particular from the electronic device 100 (precisely from the transmission module 114 of the electronic device 100).

The reception module 208 can hence receive in particular the coefficients c_{θ,ξ,x,y} transmitted by the transmission module 114 of the electronic device 100, as well as possibly, for each transmitted coefficient c_{θ,ξ,x,y}, information indicative of the reconstruction wavelet ϕ_{θ′,ξ′,x′,y′} to which this transmitted coefficient c_{θ,ξ,x,y} is assigned in the reconstructed hologram H′.

The control module 210 can then calculate the reconstructed hologram H′ by summing the different reconstruction wavelets ϕ_{θ′,ξ′,x′,y′} with weighting of each reconstruction wavelet ϕ_{θ′,ξ′,x′,y′} by the coefficient c_{θ,ξ,x,y} assigned to this reconstruction wavelet ϕ_{θ′,ξ′,x′,y′} in the reconstructed hologram H′, i.e. by denoting c′_{θ′,ξ′,x′,y′} the coefficient assigned to the reconstruction wavelet ϕ_{θ′,ξ′,x′,y′} (i.e. with c′_{θ′,ξ′,x′,y′} =_{θ,ξ,x,y}):

H′=Σ_{θ′,ξ′,x′,y′}ϕ_{θ′,ξ′,x′,y′}.c_{θ′,ξ′,x′,y′}

The control module 210 can hence control the display of the reconstructed hologram H′ by the display device 202. In practice, when the display device 202 comprises a light modulator 4 formed of pixels identified by a pair of coordinates, the control module 210 controls the pixel of coordinates (i,j) as a function of the value H′(i,j) associated with these coordinates (i,j) in the reconstructed hologram H′.

FIG. 2 schematically shows an example of display device 202 usable in the display unit 200 of FIG. 1.

The display device 202 is here a portable display device, for example a Head Mounted Display, or HMD.

The display device 202 comprises a light source 2 (monochromatic, of wavelength A), the above-mentioned light modulator 4, a lens 6 and a mirror 8, here parabolic. Such an optical system is for example described in the book “Introduction to Matrix Methods in Optics”, Anthony Gerrard, James M. Burch, Wiley, 1975, ISBN 0471296856, see in particular Chapter 18: “Matrix Methods in Paraxial Optics”.

The light modulator 4 is for example a Spatial Light Modulator, or SLM.

In practice, the mirror 8 can be made by means of a semi-transparent blade in order to superimpose the object displayed by the display device 202 to the real environment of the user.

The lens 6 is a converging lens, of focal distance f₁, making it possible to make a system such as a Fourier Transform Optical System, or FTOS.

The parabolic mirror 8 is modeled hereinafter by the combination of an inclined flat mirror 81 and a converging lens 82 of focal distance f₂ located at a distance d from the above-mentioned converging lens 6. The flat mirror 81 and the converging lens 82 are shown in FIG. 5.

FIG. 3 is a flowchart showing an example of method for reconstructing a digital hologram that may be implemented in the system of FIG. 1.

The method of FIG. 3 starts by a step E10 of taking into account construction characteristics (or intrinsic parameters) of the display device 202.

This step can be implemented in practice by the transmission of data C representative of construction characteristics of the display device 202 from the display device 202 to the transmission module 206 during an initialization phase of the display unit 200.

In conceivable embodiments, step E10 may comprise the transmission of the data C representative of construction characteristics of the display device 202 by the transmission module 206 to the electronic device 100 (thanks to the reception module 104 of the electronic device 100). In these embodiments, the data C representative of construction characteristics of the display device 202 are received by the reception module 104 of the electronic device 100 at step E12.

The method continues with a step E14 of measuring the position and direction of the display device 202 by means of the position and/or direction sensor 204. The position and/or direction sensor 204 thus produces data P representative of a position or direction characteristic of the display device 202. These data P here define a translation T representative of the position of the display device 202 and a rotation R representative of the direction of the display device 202.

The method then comprises a step E16 of transmitting, by the transmission module 206 and to the electronic device 100, the data P representative of a position or direction characteristic of the display device 202.

Step E16 here further comprises the transmission, by the transmission module 206 and to the electronic device 100, of the data C representative of construction characteristics of the display device 202.

In the example described hereinabove in which the display device is of the type shown in FIG. 2, these data C representative of construction characteristics of the display device 202 comprise the focal distance f₁ of the lens 6, as well as the focal distance f₂ and the distance d associated with the mirror 8 as explained hereinabove, and possibly the wavelength λ of the light source 2 used for displaying the hologram.

The method then comprises a step E18 of receiving, by the reception module 104 of the electronic device 100, the data P representative of a position or direction characteristic of the display device 202 and, as the case may be, the data C representative of construction characteristics of the display device 202.

The method continues with a step E20 of determining a transformation a of the above-mentioned multidimensional space E based on the data P representative of a position or direction characteristic of the display device 202 and the data C representative of construction characteristics of the display device 202.

Different examples of construction of the transformation σ as a function of the data P, C representative of characteristics of the display device 202 will now be described.

In these examples, a function F is used that, to any tuple (θ,ξ,x,y) of the multidimensional space E associates the tuple of spatial frequency coordinates (fₓ, f_{y}, X, Y), with:
fₓ=ξ cos θ
f_{y}=ξ sin θ
X=x
Y=y

where fₓ and f_{y} are the spatial frequencies (respectively along the abscissa axis x and the ordinates axis y) associated with a diffracted ray of direction θ and spatial frequency ξ.

The electronic device 100 (here, the transformation determination module 106) determines on the one hand an intrinsic transformation ρᵢ corresponding to light path changes due to the construction characteristics of the display device 202. This intrinsic transformation ρ₁ is here determined in the space-frequency coordinate space (fₓ, f_{y}, X, Y).

In practice, when the construction characteristics of the display device 202 are fixed, the intrinsic transformation ρ₁ is determined only once.

The intrinsic transformation ρᵢ may be obtained by composition of several transformations respectively associated with elements (in particular, optical elements) of the display device 202.

In the case of FIG. 2, for example, the intrinsic transformation is determined as follows: ρᵢ=ρ₄ o ρ₃ o ρ₂ o ρ₁

where o is the composition operator, ρ₁ is the transformation associated with the travel (of light) through the lens 6, ρ₂ is the transformation associated with the propagation of light from the lens 6 to the mirror 8, ρ₃ is the transformation associated with the equivalent plane mirror 81 and ρ₄ is the transformation associated with the equivalent lens 82 (see hereinabove as regards the plane mirror 81 and the lens 82 equivalent to the hyperbolic mirror 8).

In paraxial approximation, these different transformations ρ₁, ρ₂, ρ₃, ρ₄ are linear (in the space-frequency coordinate space) and can thus be written as matrices M₁, M₂, M₃, M₄, respectively, with

$${M}_{1} = ( \begin{matrix}1 & 0 & 0 & 0 \\ 0 & 1 & 0 & 0 \\ \frac{- 1}{λ {f}_{1}} & 0 & 1 & 0 \\ 0 & \frac{- 1}{λ {f}_{1}} & 0 & 1\end{matrix} )$$

$${M}_{2} = ( \begin{matrix}1 & 0 & λ d & 0 \\ 0 & 1 & 0 & λ d \\ 0 & 0 & 1 & 0 \\ 0 & 0 & 0 & 1\end{matrix} )$$

$${M}_{3} = ( \begin{matrix}- 1 & 0 & 0 & 0 \\ 0 & 1 & 0 & 0 \\ 0 & 0 & - 1 & 0 \\ 0 & 0 & 0 & 1\end{matrix} )$$

$${M}_{4} = ( \begin{matrix}1 & 0 & 0 & 0 \\ 0 & 1 & 0 & 0 \\ \frac{- 1}{λ {f}_{2}} & 0 & 1 & 0 \\ 0 & \frac{- 1}{λ {f}_{2}} & 0 & 1\end{matrix} )$$

(the matrices M₁ and M₂ being expressed with respect to the reference frame (x′,y′,z′) represented in FIG. 2, the matrix M₃ connecting the position and angles expressed in the reference frame (x″,y″,z″) to those expressed in the reference frame (x′″,y′″,z′″) and the matrix M₄ corresponding to the travel through the lens of the reference frame (x′″, y′″, z′″) into itself).

The intrinsic transformation ρ₁ is in this case a linear transformation (in the space-frequency coordinate space) defined by the matrix M:

$$M = {M}_{4} {M}_{3} {M}_{2} {M}_{1} = ( \begin{matrix}\frac{d}{{f}_{1}} - 1 & 0 & - λ d & 0 \\ 0 & 1 - \frac{d}{{f}_{1}} & 0 & λ d \\ \frac{1}{λ {f}_{1}} - \frac{\frac{d}{{f}_{1}} - 1}{λ {f}_{2}} & 0 & \frac{d}{{f}_{2}} - 1 & 0 \\ 0 & - \frac{1 - \frac{d}{{f}_{1}}}{λ {f}_{2}} - \frac{1}{λ {f}_{1}} & 0 & 1 - \frac{d}{{f}_{2}}\end{matrix} )$$

The transformation determination module 106 can thus define the intrinsic transformation ρ₁ on the basis of the data C representative of construction characteristics of the display device 202.

According to a conceivable alternative, the intrinsic transformation ρᵢ could be determined on the basis of the data C representative of construction characteristics of the display device 202 within the display unit 200. In this case, the display unit can transmit to the electronic device 100 data representative of the intrinsic transformation ρᵢ, for example the elements of the matrix M in the example envisaged hereinabove.

In other embodiments, in order to process rays having a significant inclination with respect to the optical axis and to take into account the existence of non-linear phenomena, the paraxial approximation is not used. Each transformation ρ₁, ρ₂, ρ₃, ρ₄ can hence be defined, as well as the intrinsic transformation ρᵢ, by means of a limited development (or Taylor development) with several variables of the type:

$${ρ}_{m} ( V ) = {ρ}_{m} ( {V}_{0} ) + {\sum }_{k = 0}^{n} \frac{1}{k !} {{D}_{k} ( V - {V}_{0} )}^{k}$$

where V and Vo are elements of the space-frequency coordinate space and Dₖ matrices formed by means of partial derivatives of the function ρₘ in question with respect to the different variables of this function.

The electronic device 100 (here, the transformation determination module 106) determines on the other hand an extrinsic transformation ρₑ corresponding to light ray changes due to the position and direction of the display device 202 (represented by the data P).

In the example described herein, as already indicated, the data P here define a translation T representative of the position of the display device 202 and a rotation R representative of the direction of the display device 202.

Let's denote tₓ, t_{y}, t_{z} the components of the translation T according to the three coordinate axes x, y, z (shown in FIG. 2), respectively, i.e. T=(tₓ, t_{y}, t_{z}).

Let's also denote Rₓ, R_{y}, R_{z} the rotations about the three coordinate axes x, y, z, respectively, which, combined to each other, form the rotation R.

For small rotation angles (denoted aₓ, a_{y}, a_{z}, about the three coordinate axes x, y, z, respectively), each rotation can be approximated by an affine transformation and be written as a matrix, as follows:

$${R}_{z} = ( \begin{matrix}cos {a}_{Z} & - s in {a}_{Z} & 0 \\ sin {a}_{Z} & cos {a}_{Z} & 0 \\ 0 & 0 & 1\end{matrix} ) = ( \begin{matrix}{R}_{z}^{′} & 0 \\ 0 & 1\end{matrix} )$$

$${R}_{y} = ( \begin{matrix}cos {a}_{y} & 0 & sin {a}_{y} \\ 0 & 1 & 0 \\ - s in {a}_{y} & 0 & cos {a}_{y}\end{matrix} )$$

$${R}_{x} = ( \begin{matrix}1 & 0 & 0 \\ 0 & cos {a}_{x} & - s in {a}_{x} \\ 0 & sin {a}_{x} & cos {a}_{x}\end{matrix} )$$

and R=RₓR_{y}R_{z}.

As described in the article “Global motion compensation for compressing holographic videos”, by D. Blinder, C. Schretter and P. Schelkens, vol. 26, Optics Express 2018 (20), pp. 25524-25533, the associated transformation in the 5-dimensional phase space is given by the matrix:

$${A}^{A} = ( \begin{matrix}{R}_{z}^{′} & 2 \frac{{t}_{z}}{λ} {R}_{Z}^{′} & {b}_{τ} \\ 0 & {R}_{Z}^{′} & {b}_{ω} \\ 0 & 0 & 1\end{matrix} ) with$$

$${b}_{τ} = ( \begin{matrix}{t}_{x} \\ {t}_{y}\end{matrix} )$$

$${b}_{ω} = ( \begin{matrix}{θ}_{x} \\ {θ}_{y}\end{matrix} )$$

By keeping only the first four lines of the matrix A′, a matrix A is obtained:

$$A = ( \begin{matrix}{R}_{z}^{′} & 2 \frac{{t}_{z}}{λ} {R}_{z}^{′} & {b}_{τ} \\ 0 & {R}_{z}^{′} & {b}_{ω}\end{matrix} )$$

and it may be written:

$$( \begin{matrix}{X}^{′} \\ {Y}^{′} \\ {f}_{x}^{′} \\ {f}_{y}^{′}\end{matrix} ) = A ( \begin{matrix}X \\ Y \\ {f}_{x} \\ {f}_{y} \\ 1\end{matrix} ) .$$

The matrix A thus defines the extrinsic transformation ρₑ.

In the embodiments in which the angles aₓ, a_{y}, a_{z}, the use of which is contemplated, do not allow the linear approximation used hereinabove, the extrinsic transformation ρₑ can be determined as follows.

A ray diffracted at the point of coordinates (x,y) and whose direction is defined by a polar angle θ and an azimuth angle φ (as shown in FIG. 6) is modified by a rotation R and a translation T into a ray defined by the coordinates

$$( \begin{matrix}{x}^{′} \\ {y}^{′} \\ {θ}^{′} \\ {φ}^{′}\end{matrix} ) = F ( \begin{matrix}x \\ y \\ θ \\ φ\end{matrix} )$$

where F is determined as follows.

Let's define the point q of the three-dimensional space having for coordinates (x, y, 0) in the reference frame linked to the initial hologram H, as well as the three-dimensional vector p having for coordinates in said reference system (sin(φ) cos(θ), sin(φ)sin(θ),cos(φ)).

Let's define the point q′ of the three-dimensional space by

q′=R⁻¹q−R⁻¹T

(with R and T the matrices defined hereinabove) and the vector p′ by

p′=R⁻¹p

Let's define the point q″ by

$${q}^{″} = {q}^{′} - \frac{{q}_{z}^{′}}{{p}_{Z}^{′}} {p}^{′}$$

q_{z}′ and p_{z}′ denoting the third coordinate of q′ and p′, respectively. The case in which p_{z}′ is null is not described because it corresponds to a direction incompatible with the intended applications (display system behind the plane of the initial hologram).

The transformation F is then given by

$$( \begin{matrix}{x}^{′} \\ {y}^{′}\end{matrix} ) = ( \begin{matrix}{q}_{x}^{″} \\ {q}_{y}^{′}\end{matrix} ) and$$

$$( \begin{matrix}{θ}^{′} \\ {φ}^{′}\end{matrix} ) = {{G}^{- 1}}^{°} {R}^{∘} G ( \begin{matrix}θ \\ φ\end{matrix} )$$

where G is the function

$$G ( \begin{matrix}θ \\ φ\end{matrix} ) = ( \begin{matrix}sin ϕ cos θ \\ sin ϕ sin θ \\ cos ϕ\end{matrix} )$$

whose inverse is given by

$${G}^{- 1} ( \begin{matrix}x \\ y \\ z\end{matrix} ) = ( \begin{matrix}ar cos ( z ) \\ arc tan ( y )\end{matrix} )$$

In the example described herein, the transformation determination module 106 can thus determine, at step E20, a transformation σ of the multidimensional space E that takes into account the intrinsic transformation ρᵢ and the extrinsic transformation ρₑ.

The intrinsic ρ₁ and extrinsic ρₑ transformations having here been determined in the space-frequency coordinate space, the function Γ defined hereinabove is used to take these transformations in the multidimensional space E into account. In other words: σ=Γ⁻¹ o ρ o Γ, where ρ is the transformation of the space-frequency coordinate space obtained by combination of the inverse ρ₁⁻¹ of the intrinsic transformation ρᵢ, and the extrinsic transformation ρₑ: ρ=ρ₁⁻¹ o ρₑ.

It can be observed that the extrinsic transformation ρₑ is here defined from the plane of the initial hologram to the plane of the eye and that the above combination thus uses the function ρ₁⁻¹ that goes from the plane of the eye to the plane of the light modulator 4 (the intrinsic function ρ₁ defined hereinabove going from the plane of the light modulator 4 to the plane of the eye).

The method of FIG. 3 then continues with a step E22 of reassignment of each coefficient c_{θ,ξ,x,y} (stored in the storage module 103 in association with a definition wavelet ϕ_{θ,ξ,x,y}) to a reconstruction wavelet ϕ_{θ,ξ,x,y} defined by a reconstruction tuple (θ′,ϵ′, x′, y′) such that: (θ′, ξ′, x′, y′)=σ[(θ, ξ, x, y)].

In practice, for a set of definition tuples (θ, τ, x, y), the image σ[(θ,ξ, x, y)] of the tuple concerned by the transformation σ is determined, then the coefficient c_{θ,ξ,x,y} associated with the definition wavelet ϕ_{θ,ξ,x,y} defined by this definition tuple is assigned to the reconstruction wavelet ϕ_{θ′,ξ′,x′,y′} defined by the determined image σ[(θ, ξ, x, y)] (or, when a predetermined set of reconstruction wavelets is considered, to the reconstruction wavelet whose definition parameters are the closest to the image σ[(θ, ξ, x, y)]).

In the example described herein, this reassignment step E22 is implemented by the reassignment module 112.

The method of FIG. 3 then comprises a step E24 of selecting coefficients c_{θ,ξ,x,y} whose consideration affects the display by the display device 202. The coefficients c_{θ,ξ,x,y} assigned (after step E22) to a reconstruction wavelet ϕ_{θ,ξ,x,y} relevant for the display device 202, i.e. defined by a tuple (θ′, ξ′, x′, y′) verifying a predetermined criterion, are thus selected.

In the example described herein, the coefficients c_{θ,ξ,x,y} assigned to the reconstruction wavelets ϕ_{θ′,ξ′,x′,y′} defined by a tuple (θ′, ξ′, x′, y′) such that:

Γ(θ′, ξ′, x′, y′) ∈ S are selected,

where S is the sub-set of the space-frequency coordinate space defined as follows: [−Sₓ/Nₓ, Sₓ/Nₓ]×[−S_{y}/N_{y}, S_{y}/N_{y}]×[−Nₓ/2, Nₓ/2]×[−N_{y}/2, N_{y}/2], and where Nₓ and N_{y} are the horizontal and vertical resolutions, respectively, of the light modulator 4 and Sₓ and S_{y}the horizontal and vertical dimensions, respectively, of the light modulator 4.

The maximum diffraction angles θₓ and θ_{y} that may be obtained (in the horizontal and vertical directions, respectively) are indeed given by:

θₓ=arcsin(λNₓ/2Sₓ) and

θ_{y}=arcsin(λN_{y}/2S_{y}),

which correspond to the frequencies 2Sₓ/Nₓ and 2S_{y}/N_{y}, respectively.

As an alternative, rather than carrying out a reassignment step for all the coefficients c_{θ,ξ,x,y} of the digital hologram H, then a selection step as just explained above, it is possible to carry out the reassignment step for only the coefficients c_{θ,ξ,x,y} associated with a definition wavelet ϕ_{θ,ξ,x,y} defined by a definition tuple (θ, ϵ, x, y) whose image (θ′, ξ′, x′, y′)=σ[(θ, ξ, x, y)] verifies the predetermined criterion, i.e. whose image (θ′, ξ′, x′, y′)=σ[(θ, ξ, x, y)] verifies Γ(θ′, ξ′, x′, y′) ∈S with the notations used hereinabove.

The method continues with step E26 in which the transmission module 114 of the electronic device 100 transmits on the communication network I the coefficients c_{θ,ξ,x,y} selected at step E24 and, for each selected coefficient c_{θ,ξ,x,y} information indicative of the reconstruction wavelet ϕ_{θ′,ξ′,x′,y′} to which this selected coefficient c_{θ,ξ,x,y} has been assigned at the reassignment step E22.

The reception module 208 of the display unit 200 receives the transmitted coefficients c_{θ,ξ,x,y} (as well as, here, the information indicative of the reconstruction wavelet ϕ_{θ′,ξ′,x′,y′} to which each coefficient c_{θ,ξ,x,y} is assigned) at step E28.

The set of coefficients c_{θ,ξ,x,y} respectively assigned to the reconstruction wavelets ϕ_{θ′,ξ′,x′,y′} defines the reconstructed hologram H′.

The reconstructed hologram H′ can hence be calculated (here by the control module 210) at step E30 by summing the different reconstruction wavelets ϕ_{θ′,ξ′,x′,y′} with weighting of each reconstruction wavelet ϕ_{θ′,ξ′,x′,y′} by the coefficient c_{θ,ξ,x,y} assigned to this reconstruction wavelet ϕ_{θ′,ξ′,x′,y′} in the reconstructed hologram H′, i.e. by denoting c′_{θ′,ξ′,x′,y′} the coefficient assigned to the reconstruction wavelet ϕ_{θ′,ξ′,x′,y′} (i.e. with c′_{θ′,ξ′,x′,y′}=c_{θ,ξ,x,y}):

H′=Σ_{θ′,ξ′,x′,y′}ϕ_{θ′,ξ′,x′,y′}c_{θ′,ξ′,x′,y′}

The method then continues with step E32 in which the reconstructed hologram H′ is displayed by the display device 202.

The method then loops to step E14 for taking into account (as the case may be) a new position or direction of the display device 202.

An alternative embodiment of a part of the just-described method will now be described with reference to FIG. 4.

According to this alternative, steps E22 and E24 are replaced by steps E40 and E44 described now.

In this alternative, step E40 carries out a step of determining a criterion modified as a function of the transformation σ determined at step E20 of the above-mentioned criterion.

In the example described herein, the sub-set S′ of the multidimensional space E corresponding to the antecedent of the above-mentioned sub-set S by the transformation σ is determined: S′=σ⁻¹ o Γ⁻¹ (S)=Γ⁻¹ o ρ⁻¹ (S), where ρ is the transformation already introduced hereinabove: ρ=ρi⁻¹ o ρₑ. The so-determined sub-set S′ is called hereinafter the “modified sub-set”.

The extrinsic transformation ρₑ depending on the data P representative of the position and/or direction characteristics of the display device 202, the sub-set S′ also varies as a function of these data P.

The alternative then continues with a step E42 of selecting coefficients c_{θ,ξ,x,y} whose associated definition wavelet ϕ_{θ,ξ,x,y} is defined by a tuple of coordinates (θ, ξ,x,y) verifying the modified criterion, i.e. herein belonging to the modified sub-set S′.

The method continues in this case with a step E44 of reassigning each selected coefficient c_{θ,ξ,x,y} to a reconstruction wavelet ϕ_{θ′,ξ′,x′,y′} defined by a reconstruction tuple (0′, ξ′, x′, y′) image of the definition tuple (θ, ξ,x,y) associated with this selected coefficient c_{θ,ξ,x,y}, i.e. such that: (θ′, ξ′, x′, y′)=σ[(θ, ξ, x, y)].

A conceivable possible design for storing the coefficients will now be described; this possible design is applicable in the different examples of implementation described hereinabove.

In the case where a great number of coefficients c_{θ,ξ,x,y} associated with the definition wavelets ϕ_{θ,ξ,x,y} are zero or negligible with respect to a given relevance threshold, it can be advantageous to organize these coefficients c_{θ,ξ,x,y} as a kd tree (technique whose principle is known by the person skilled in the art), in order to reduce the time of search for a coefficient c_{θ,ξ,x,y} corresponding, by the transformation σ, to the reconstruction tuple (θ′, ξ′, x′, y′).

In this alternative, the definition coefficients c_{θ,ξ,x,y} are associated with the leaves of a binary tree (or kd tree) created by recursively subdividing the set E of the tuple of coordinates associated with the coefficients in each dimension successively: the set E is first subdivided into two sub-sets E₁⁰ and E₂⁰ represented by a threshold value θ₀ in such a way that a tuple (θ, ξ, x, y) is associated with a coefficient in E₁⁰ if and only if θ<θ₀. The second stage of the tree is filled in the same way but considering the variable ξ, and so on by proceeding cyclically on the variables θ, ξ, x and y until the partitioned sets contain only one element.

During the selection step E24, the tuples (θ′, ξ′, x′, y′) defining reconstruction wavelets and corresponding to the set S are scanned, and for each of them, the antecedent (θ, ξ, x, y) of (θ′, ξ′, x′, y′) by the transformation a is obtained and a recursive search is made in the above-described tree. The reached leaf provides the coefficient c_{θ,ξ,x,y} corresponding to the corresponding definition wavelet ϕ_{θ,ξ,x,y}.

1. A method for reconstructing a digital hologram for the digital hologram to be displayed by a display device, the digital hologram being represented by a set of coefficients respectively associated with a plurality of definition wavelets, each of the definition wavelets being defined by a tuple of coordinates in a multidimensional space, the method comprising:
determining a transformation of said multidimensional space, based on at least one data item representative of a characteristic of the display device; and
generating a reconstructed hologram by assigning each of the coefficients of at least some of said coefficients to a reconstruction wavelet defined by a reconstruction tuple image, by the determined transformation, of the tuple of coordinates defining the definition wavelet associated with the respective coefficient.

2. The method according to claim 1, wherein said characteristic of the display device is a construction characteristic of the display device.

3. The method according to claim 1, wherein said characteristic of the display device is a position or direction characteristic of the display device.

4. The method according to claim 1, wherein said transformation is determined based on a first data item representative of a construction characteristic of the display device and a second data item representative of a position or direction characteristic of the display device.

5. The method according to claim 1, wherein the generating the reconstructed hologram comprises:
assigning each of the coefficients associated with the respective definition wavelet, defined by the respective tuple of coordinates to the reconstruction wavelet defined by the respective reconstruction tuple image of the respective tuple of coordinates by the determined transformation, and
selecting the coefficients assigned to reconstruction wavelets defined by the tuples of coordinates verifying a predetermined criterion.

6. The method according to claim 1, wherein the generating the reconstructed hologram comprises:
determining a criterion modified based on the determined transformation and a predetermined criterion, and
selecting coefficients whose associated definition wavelet is defined by a tuple of coordinates verifying the modified criterion.

7. The method according to claim 1, wherein the generating the reconstructed hologram comprises scanning a binary tree having leaves that correspond to the coefficients of said set of coefficients.

8. A method for displaying a digital hologram, the method comprising:
reconstructing the digital hologram by the method according to claim 1; and
displaying the reconstructed hologram by said display device.

9. A reconstruction device for reconstructing a digital hologram for the digital hologram to be displayed by a display device, the reconstruction device comprising:
at least one processor configured to
store a representation of the digital hologram comprising a set of coefficients respectively associated with a plurality of definition wavelets, each of the definition wavelets being defined by a tuple of coordinates in a multidimensional space,
determine a transformation of said multidimensional space as a function of at least one data item representative of a characteristic of the display device, and;
generate a reconstructed hologram by assigning each of the coefficients of at least some of said coefficients to a reconstruction wavelet defined by a reconstruction tuple image, by the determined transformation, of the tuple of coordinates defining the definition wavelet associated with the respective coefficient.

10. The reconstruction device according to claim 9, wherein the at least one processor is further configured to
receive said representative data item, and
transmit the assigned coefficients, and, for each of the assigned coefficients, information indicating the reconstruction wavelet to which the respective selected coefficient is assigned in the reconstructed hologram.

11. A system comprising:
the reconstruction device according to claim 9; and
said display device.

12. The method according to claim 2, wherein the generating the reconstructed hologram comprises:
assigning each of the coefficients associated with the respective definition wavelet, defined by the respective tuple of coordinates, to the reconstruction wavelet defined by the respective reconstruction tuple image of the respective tuple of coordinates by the determined transformation, and
selecting the coefficients assigned to reconstruction wavelets defined by the tuples of coordinates verifying a predetermined criterion.

13. The method according to claim 2, wherein the generating the reconstructed hologram comprises:
determining a criterion modified based on the determined transformation and a predetermined criterion, and
selecting coefficients whose associated definition wavelet is defined by a tuple of coordinates verifying the modified criterion.

14. The method according to claim 2, wherein the generating the reconstructed hologram comprises scanning a binary tree having leaves that correspond to the coefficients of said set of coefficients.
